(19) United States
(12) Patent Application Publication
(10) Pub. No.: US 2019/0332734 A1
(43) Pub. Date: Oct. 31, 2019

(54) VIRTUAL ARTICULATOR

(71) Applicant: SICAT GMBH & CO. KG, BONN (DE)

(72) Inventors: NILS HANSSEN, BONN (DE); DIRK FREYER, KOELN (DE); GERHARD ZUENDORF, BONN (DE)

(73) Assignee: SICAT GMBH & CO. KG, BONN (DE)

(21) Appl. No.: 16/345,727

(22) PCT Filed: Oct. 16, 2017
(86) PCT No.: PCT/EP2017/076357

§ 371 Date: Apr. 29, 2019

(30) Foreign Application Priority Data
Oct. 31, 2016 (DE) 10 2016 120 762.4

(51) Int. Cl. G06F 17/50; G06F 17/18; G06T 15/08; G06T 17/20; A61C 11/00

(52) U.S. Cl. CPC G06F 17/5018; G06F 17/18; G06T 15/08; G06T 2210/41; A61C 11/00; G06F 2217/16; G06T 17/20

(57) ABSTRACT

A method for producing a computer-aided virtual articulator for dentistry includes recording and collating body-related data from a plurality of persons to provide a data collection, generating a model of a masticatory apparatus from the data collection via statistical methods, and using the model to supplement body-related data recorded from a single patient to provide a simulated individual movement model of the masticatory apparatus of the single patient and to simulate a movement of the masticatory apparatus.

### CROSS REFERENCE TO PRIOR APPLICATIONS

This application is a U.S. National Phase application under 35 U.S.C. § 371 of International Application No. PCT/EP2017/076357, filed on Oct. 16, 2017 and which claims benefit to German Patent Application No. 10 2016 120 762.4, filed on Oct. 31, 2016. The International Application was published in German on May 3, 2018 as WO 2018/077653 A1 under PCT Article 21(2).

### FIELD

The present invention relates to a method and to a device for producing a computer-aided virtual articulator for dentistry for the simulation of masticatory movements of the human masticatory apparatus, comprising body-related data recorded from a plurality of persons and collated to form a data collection. A model of the masticatory apparatus is generated from the data collection using statistical methods in a computer environment.

### BACKGROUND

Such a procedure was previously described in WO 2016/079 071 A1.

A patient suffering from pain in the masticatory apparatus often consults a dentist so that the dentist can make a diagnosis. The diagnosis is typically followed by a therapy recommendation and also, under certain circumstances, by a dental laboratory being given commissioned work to make a dental prosthesis for the patient. In order to be able to correctly make the dental prosthesis, the dental technician expediently uses a so-called “articulator”, which imitates a three-dimensional masticatory movement of the patient via mechanical joints. The more precisely this simulated masticatory movement corresponds to the actual masticatory movement of the patient, the more accurately and better the dental prosthesis can be made. A high accuracy is particularly important here since inaccuracies even in the micrometer range can adversely affect the patient's mastication sensation. Consider, for example, how irritating an apple fiber of this order of magnitude lodged in the oral cavity/interdental space can be.

The standard mechanical articulators currently used attempt to simulate the masticatory movement of a person three-dimensionally via a plurality of movable joints. However, this generally turns out only to be very inadequate since the bandwidth of human masticatory movements is too complex for such mechanical solution approaches. Often in dentistry a therapy is planned or a dental prosthesis is made for a patient using an idealized, already existing mechanical standard articulator, which often results in a poorly seated dental prosthesis, since every patient has an individual anatomy.

The individual jaw and masticatory movements of the patient can be recorded by various methods. Axiography, for example, can determine and record the masticatory movement of the patient via a computer. Owing to the resilience of the skin, these recordings are often not reproducible, and so each measurement yields different results. It has long been known from physics that experimental measurements in practice actually always have Gaussian-distributed statistical uncertainty distributions. It is disadvantageous that in practice no method for producing an articulator has to date been described in which different movement profiles of the masticatory apparatus are evaluated statistically so as to form, for example, a mean value used for producing the articulator.

In order to record a movement data set from the patient, the first step typically involves making a tomograph of the patient by digital volume tomography (DVT) in order to identify the structures of the masticatory apparatus of the patient. This data set is then combined with data of the so-called 4D jaw motion tracking method (JMT), which is used to measure the masticatory movement. A temporally resolved data set of the masticatory apparatus of the patient can be generated from the combination of both data sets. In the event of an incomplete temporally resolved movement data set (for example, if some movement phases are completely missing), the prior art disadvantageously fails to describe a method by which the “intermediate movements” not recorded can be deduced, which are important for the precise production of a dental prosthesis.

Even if the limit movements are recorded precisely and completely, they cannot be transferred precisely to a mechanical articulator, since the mechanism thereof only permits very specific setting possibilities, wherein these restrictions also apply to conventional virtual articulators, since the latter are modeled on the mechanical articulators. Complex three-dimensional masticatory movements are typically reduced to single scalar values, for example, the Bennett angle, with the sometimes disadvantageous result that different masticatory movements are represented by the same Bennett angle. A loss of information here clearly occurs.

Even if an articulator used in practice were by chance able to simulate a recorded masticatory movement of a specific patient, this articulator is nevertheless disadvantageously unable to make precise predictions about movements of the masticatory apparatus of said patient which go beyond the recorded masticatory movements. This primarily concerns the complex pivoting-sliding movements.

### SUMMARY

An aspect of the present invention is to provide a method and a device for producing a virtual articulator so that the masticatory movements of a patient are represented completely, precisely and individually using the virtual articulator as far as possible.

In an embodiment, the present invention provides a method for producing a computer-aided virtual articulator for dentistry which includes recording and collating body-related data from a plurality of persons to provide a data collection, generating a model of a masticatory apparatus from the data collection via statistical methods, and using the model to supplement body-related data recorded from a single patient to provide a simulated individual movement model of the masticatory apparatus of the single patient and to simulate a movement of the masticatory apparatus.

### BRIEF DESCRIPTION OF THE DRAWINGS

The present invention is described in greater detail below on the basis of embodiments and of the drawings in which:

FIG. 1 shows a method and a device according to the present invention for generating and representing a virtual articulator for dentistry;

FIG. 2 schematically shows how an incomplete data set of a patient is supplemented to form a complete data set via the method according to the present invention;

FIG. 3 shows an interaction of a user with the virtual articulator; and

FIG. 4 shows the outputs of a diagnosis and a therapy preview simulation on a display device by the virtual articulator.

### DETAILED DESCRIPTION

The central concept realized in the case of the method according to the present invention is that the model generated from the data collection is used to supplement the body-related data recorded from a patient to form an individual movement model of the masticatory apparatus of the patient and to simulate the masticatory apparatus using the articulator. Through the statistical evaluation of the body-related data of the plurality of persons in a data collection, it is possible to deduce functional relationships of the human masticatory apparatus. The data from various persons complement one another in the data collection so that a complete 4D movement sequence of the masticatory apparatus is generated. For a specific patient, volumetric tomographic data is typically recorded and captured for only a small number of movement phases. If movement phases different therefrom are captured from other patients, both can be supplemented to form a complete set of movement phases. Identical phases are used to determine statistical relationships and to determine the most probable masticatory movement among a multiplicity of persons. The application of statistical methods provides answers to questions such as, for example, what is the most probable masticatory movement of the data collection and how probable is it that the recording of a specific patient fits the overall picture of the data collection? If the patient, on the basis of the data present from said patient, exhibits a great body-related correspondence to at least a subset of the data collection, then this increases the probability that the simulation of the masticatory movement of this patient corresponds to at least this subset of the data collection and can be consulted for the use of the virtual articulator, with the result that the dental technician can make a dental prosthesis precisely and correctly.

The body-related data can, for example, additionally have information indicating with what probability a specific finding or a disease is present, such that this information is taken into account in the modeling. Mirror-symmetrical properties can also optionally be taken into account both in the case of the input data and in the case of the output data of the model. By way of example, if data from the left region of the masticatory apparatus is present, it is possible, via mirror-symmetrical assumptions, to deduce the right region or to take this information into account in the modeling.

The body-related data of the patient is advantageously transmitted via an interface and added to the data collection. The interface makes it possible to gather the data in different medical dental clinics/centers and/or practices and to advantageously combine the data to form a single data collection. The quantity of the data collection can thereby be increased. This is important for statistical evaluations since it is here usually necessary to provide a minimum number of body-related data from persons in order to be able to make statistical statements. Evidence-based medicine specifies methods in which a minimum number of data must be gathered in order to be able to make significant statements.

The body-related data can, for example, comprise data from imaging methods and/or data from the anamnesis and/or movement data. The anamnesis data comprises information about the sex and/or the height and/or the age and/or the origin and/or the BMI and/or pre-existing conditions and/or findings and/or other treatment-relevant characteristics of the patient. In medicine, these treatment-relevant characteristics of a patient are called subgroups. These subgroups can, for example, also be intended to be gathered as completely as possible for the plurality of persons whose data form the data collection. These subgroups are used in medicine and in clinical research to enable patients to be differentiated from one another and to identify similar patients. The subgroups mentioned above have in this case proved to be expedient and at the same time to be clinically relevant. The listing of the subgroups should not, however, be understood as an exhaustive enumeration, and the addition of further subgroups does not depart from the scope of the present invention. The movement data reproduce the movement of the masticatory apparatus and are recorded, for example, by a jaw motion tracking system (JMT).

The anamnesis data can, for example, be used to form different patient populations having similar properties for the model, wherein the patient is assigned to at least one of said patient populations and for each of these patient populations a specific articulator assigned thereto is generated. A small child and an adult obviously differ at least with regard to the categories of age and height. This has the consequence that the masticatory apparatuses and the masticatory movement of a small child and of an adult are configured differently. Assigning the patient to a patient population having the best correspondence to said patient provides that the correct model is selected for the patient, wherein a dedicated model of the masticatory apparatus is advantageously generated for each patient population. If appropriate, it is possible to add further categories for differentiating patients and even to generate a plurality of models for each patient population, wherein statistical methods are used to indicate which of these models is most likely to correspond to the patient. Significance values from statistical tests such as, for instance, the Ancova, t-test or chi-square test can, for example, be indicated in this regard. It is also possible to predefine the desired statistical significance and to extend the corresponding patient population until the data collection is large enough to make statements with regard to the predefined significance.

The imaging methods can, for example, comprise a digital volumetric tomographic data recording (DTV) and/or a data recording via a jaw motion tracking (JMT) system and/or other suitable measuring methods for describing the anatomy of the masticatory apparatus. As a result of the use of X-rays in the imaging methods, the electron density of the structures of the masticatory apparatus is determined, from which information about the bone and/or tooth structure and/or inflammation of masticatory apparatus/gingivae can, for example, be obtained. Instead of X-rays, proton radiography or magnetic resonance imaging can in principle also be used for these imaging methods. In this case, it is crucial at the same time to provide an efficient image recording which provides a large amount of information and subjects the patients to the least possible radiation burden.

The imaging data from different measuring methods are advantageously introduced into a common reference system. A common reference system is important for collating imaging data recorded in different clinics, for example, to form a common data collection, such that they can be evaluated jointly and regularities can arise therefrom. For example, in a first clinic provision can be made for transilluminating the patient from the left half of the patient's face, whereas a second clinic provides a transillumination from the right half of the patient's face. In order to be able to carry out a later evaluation for producing the virtual articulator, the data must accordingly be introduced into the common reference system so that the left half of the face and the right half of the face are not confused.

The body-related data can, for example, comprise surface data of the teeth and/or bite forces of the masticatory apparatus. If the surface data of the teeth is known, it possible for the dental technician to make the dental prosthesis in a precise manner at the first attempt, thereby omitting complex rework for correction. The detection of the bite forces is an important item of information for the dentist in order to detect and be able to assess the dynamic characteristic of the masticatory apparatus of the patient.

The bite force can, for example, be determined on the basis of the temporal profile of the occlusion of the teeth which is recorded by the imaging methods. This has the advantage that the patient need not undergo additional measurements for determining his/her bite force. It is possible from previously recorded bite forces to derive regularities regarding the way in which the temporal profile of the occlusion correlates with the forces that occur.

In an embodiment of the method, the data recorded by the imaging methods can, for example, comprise recordings of a plurality of movement phases of the masticatory apparatus and/or recordings at different points in time. The more movement phases or the more different points in time captured by the imaging methods, the better the temporal resolution with which the movement of the masticatory apparatus can be reproduced and statistical uncertainties can be reduced. The respective movement phases are also labeled with further therapy-relevant information. Said therapy-relevant information comprises the description of pathological findings or other conspicuous features.

The individual movement model of the patient that is simulated by the virtual articulator can, for example, be represented on a display device and/or further output information and/or a therapy preview simulation are/is provided. An expedient display device in this case is, for example, a computer monitor or a screen of a mobile terminal such as, for example, a smartphone or a tablet. Further output information is helpful to facilitate the assessment of the movement model simulated by the virtual articulator and to make said assessment more precise for the dentist or the patient. A therapy preview simulation advantageously shows how a planned intervention affects the masticatory movement of the patient in this case. The dentist or the dental technician can thereby expediently simulate a plurality of scenarios and report the effects thereof. By way of example, the question may arise for the dentist as to whether the latter ought to initiate a therapy or rather leave a patient's masticatory apparatus in the untreated state, since a therapy may actually lead to a worsening of the overall situation for the patient. The therapy preview helps to estimate and assess this, for example, by the indication of significance values.

In an embodiment of the present invention, the virtual articulator can, for example, indicate on the display device whether the body-related data recorded from the patients are sufficient for producing the simulated movement model and what measurements possibly still need to be carried out. For this purpose, the dentist can, for example, stipulate a certain patient-specific precision of the measurement. If a precision required for a first patient is not as high as that required for a second patient, then unnecessary measurements for the first patient are obviated. If the display device indicates that the patient's age still needs to be added in order that the patient can be assigned to the corresponding data collection, this information is requested from the patient and added. In this case, however, the display device can also indicate whether, for example, an imaging or movement data set is of an insufficient quality, or whether even further imaging or movement data sets must be created in order to generate a precise simulated movement model of the patient. The articulator interactively issues commands that facilitate the measurement or make it possible in the first place. One example of such a command by the articulator would be: “In the next movement recording please open the lower jaw and at the same time push it toward the left.”

The movement of selected distinctive points of the masticatory apparatus is represented on the display device by means of the articulator. In this case, the distinctive points can, for example, be those which are of preeminent importance in dentistry, so that they can, for example, be considered and studied. It is thus possible to examine and quantify the spatial profile of distinctive points such as, for example, individual dental cusps. The movement of the condyle of the jaw joint and distinctive points therefor can also be examined and quantified with regard to their movement.

During the representation of the movement model on the display device, anatomical points of the masticatory apparatus are expediently fixed with regard to a translational and/or a rotational movement, wherein the virtual articulator automatically calculates and indicates the resultant degrees of freedom of the model. This is testament to a guided mouth opening on the real patient. This enables the model of the masticatory apparatus, for example, to be revolvable or rotatable about a point or about an axis and to be able to be considered from different viewing angles.

The further output information can, for example, indicate with what probability the patient should be assigned to a specific patient population and/or with what probability a specific disease or a specific finding for the patient is present. By way of example, if the probability indication for two possible diseases is of approximately equal magnitude and a specific significance level (e.g., alpha=0.05) is not reached, the dentist can undertake further diagnostic measures in order to be able to make an assessment on the basis of an improved data situation.

In an embodiment of the present invention, the simulated movement model of the masticatory apparatus of the patient can, for example, be output as a digital volumetric tomographic data set with surface data of at least a portion of the teeth of the patient. This data set can be emptied into further computer systems via the interfaces and also exchanged between different researchers or dentists at different clinics. It is moreover important to provide a uniform, informative output standard, thereby increasing the compatibility of virtual articulators among one another. In this case, the digital volumetric tomographic data set in as many movement phases as possible has the relevant information for issues appertaining to dentistry.

Finite element methods can, for example, be used for the model, which have proved worthwhile as a method of numerical approximation.

The virtual articulator is advantageously made available to external users via an interface, wherein the data collection is at the same time kept confidential and remains inaccessible to external users. This provides that the data of patients is protected but at the same time the data collection is available for evaluation by third parties.

The present invention also provides a device according to the method described above, which device comprises an apparatus for recording an imaging data set of the masticatory apparatus of patients, a computer having a processor unit for producing the virtual articulator, an interface for inputting the imaging data set into the computer, and a display device for representing the virtual articulator.

Further advantages, properties and developments of the present invention are evident from the claims and also from the embodiments described below under reference to the drawings.

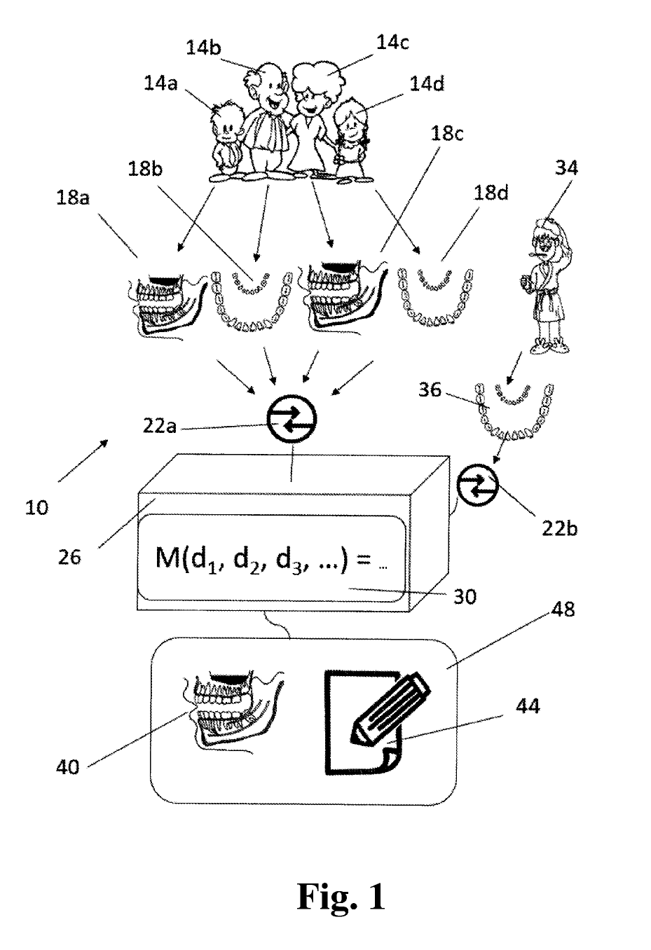

FIG. 1 shows the method 10 according to the present invention for generating the virtual articulator. In this case, body-related data sets, in particular digital volumetric tomographic (DVT) data sets, jaw motion tracking (JMT) data sets and/or data sets of some other suitable measuring method, are gathered from a plurality of persons 14a, b, c, d. At least one individual data set 18a, b, c, d is assigned to each person 14a, b, c, d, as a result of which the different anatomy of each person 14a, b, c, d is taken into account. The data sets 18a, b, c, d are read in via an interface 22a, which is configured, for example, as an Internet interface, a USB interface and/or some other suitable interface for transmitting electronic data. The interface 22a enables the data sets 18, for example, to be able to be gathered in different centers and/or clinics but nevertheless to be collatable and combinable to form a data collection in a single computer- or server-like system 26. The data sets 18 of different measuring methods are in particular combinable in this case.

A model M 30 of a virtual masticatory apparatus which represents the basis for the virtual articulator is generated from the data collection via statistical methods. In this case, correlations, relationships and dependencies are evaluated both between a plurality of data sets 18 of a specific person 14 and between data sets of different persons 14. Expediently, the data sets 18 additionally comprise subgroup categories such as the age and the height of the persons 14a, b, c, d assigned to them and influence the model 30 as independent variables di. In a first implementation configuration, a single model 30 is generated, which represents an articulator that arises from the data collection as the most probable configuration. In another configuration, a plurality of models 30 of the articulator are generated, which take account of the subgroup categories separately, for example, so that different models 30 are generated, for example, for patients under 16 years of age and for patients over 16 years of age. Where only the first configuration is described below, this nevertheless includes the second configuration.

The model M according to the present invention can, for example, be produced in the following way:

The k different properties of each patient of the collection are represented in a k-multidimensional vector. A k-dimensional feature space is spanned by the multiplicity of k-dimensional vectors. The feature space is more or less densely occupied depending on the extent of the collection data. A machine learning method, such as deep learning, is then used to search for relationships between the individual k-dimensional data points in the feature space. The machine learning method attempts to describe the k-dimensional feature space in an as compact representation as possible of only a few parameters. The background is the insight that often only a few hidden parameters cause the observed phenomena or the relationships thereof. The method can best be made clear on the basis of two features in two-dimensional space. By way of example, if the relationship between age and the maximum opening of the jaws is concerned, the points in a two-dimensional graph—age on the abscissa and maximum jaw opening on the ordinate—represent the feature space for age and maximum opening of the jaw. Age and maximum opening may, for example, be approximately in a linear ratio. By interpolation of the data points with a linear function, this relationship is described as a model. That linear function which minimizes the error of the model is chosen. The “interspaces” between the measured data points can then be interpolated and extrapolated on the basis of the linear relationship found; data points that were never measured previously can be estimated. This method can be extended to arbitrary dimensions and arbitrary function types (quadratic, exponential and/or others). Through skillful weighting, the feature space is reduced to a few relevant data points. This can be done with a similarity measure that takes account of only those data points of the collection which (at least regarding some parameters) are similar to the parameters of the current patient. By way of example, those data points of the feature space for which the patient has a similar age can be taken into account.

The model M 30 can, for example, be present in a computer 26 at a dental clinic and/or a dental office so that the model M 30 can be used according to the present invention in daily routine operation according to the following method:

A patient 34 has toothache or problems with his/her teeth. The patient 34 requires a dental prosthesis and therefore visits a dentist. In order to be able to make a diagnosis, the dentist records a DVT data set 36, a JMT data set 36 and/or an optical surface data set 36 of the patient 34 and loads said DVT data set 36, JMT data set 36 and/or an optical surface data set 36 via a second interface 22b onto the computer 26 where it influences the model 30 as a further parameter di. The model M 30 is then used to supplement the data set 36 recorded from the patients 34 to form an individual movement model of the masticatory apparatus of the patient 34 and to simulate the latter's masticatory movement in temporally resolved three-dimensional space. The individual virtual articulator 40 of the patient 34 is displayed together with further output information 44 on a screen 48 and can be assessed and used by the dentist and/or the dental technician.

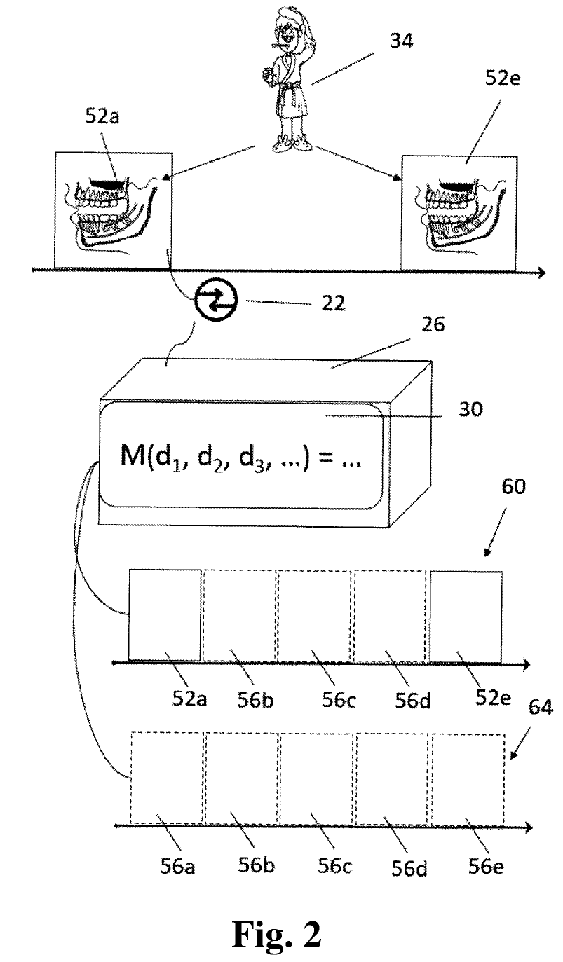

FIG. 2 shows once again the patient 34 for whom a DVT and/or a JMT data set 36 is generated, wherein the JMT data set can, for example, comprise a plurality of movement sections of the patient 34, such as opening and closing states. By combining the DVT data set 36 with this temporally resolved JMT data set 36, it is possible to represent the masticatory movement of the patient 34 in a DVT data set 36. It is assumed in the present case that a complete JMT data set 36 is present if five movement sections are recorded. Fixing the number of five movement sections is arbitrary and merely serves for illustration purposes, such that the number of movement sections is in principle freely selectable. The higher the number of movement sections, the better the temporal resolution of the corresponding JMT data set 36. This means, specifically, that the motion capture via the JMT system is effected with a higher time resolution and therefore more precisely. In FIG. 2, what is recorded from the patient 34, for whatever reason, is not a complete JMT data set 36, but rather only the two movement sections 52a,e, representing, for example, the opening and closing state, respectively, of the masticatory apparatus. The JMT data set 36 recorded for the patient 34 is thus incomplete since no information about the movements between the opening and closing states is recorded.

The recorded data 36 is transmitted to the computer 26 via the interface 22 and influence the model 30 stored in the computer 26 as input variables. With the aid of the model M 30, the computer 26 generates either a padded DVT and/or JMT data set 60 or a completely regenerated DVT and/or JMT data set 64. In the case of the padded data set 60, the movement phases 52a,e recorded from the patient are accepted into the padded data set 60 and the missing movement phases 56b,c,d are generated by the model M 30 and integrated at the temporally correct position within the padded data set 60. Alternatively, in the completely regenerated data set 64, all five movement sections 56a,b,c,d are regenerated by the model M 30 and integrated at the temporally correct position within the completely regenerated data set 64. The data sets 60, 64 generated in this way are represented subsequently, as shown in FIG. 1, as a virtual articulator 40 on the screen 48 and represent an individual, precise movement model of the patient 34.

The virtual articulator 40 has at least one, and, for example, a plurality of the following embodiments which are explained in greater detail below:

With regard to the patient 34, the virtual articulator 40 is able:

1) To represent a complete, precise simulation of the masticatory movement;

2) To perform an automatic diagnosis;

3) To produce a therapy recommendation;

4) To generate a therapy preview;

5) To generate an optimum dental prosthesis;

6) To produce automatic therapy planning;

7) To provide optimum restorative care; and

8) To replace missing teeth.

In an embodiment of the present invention, the virtual articulator 40 simulates a complete, precise masticatory movement of the patient once the model M 30 has previously been trained with the data of other patients or subjects 14. Various measuring methods, enumerated non-exhaustively below, are taken into consideration as possible input variables for the model M 30. These include:
DVT data sets 18;
Optical surface data sets;
Jaw motion tracking data sets (JMT); and
Subgroup categories.

The complete, precise and patient-specific simulations of masticatory movements by the model M 30 may yield the following results:
M(DVT, surface data, JMT partial measurement)=JMT full measurement
M(DVT, surface data, JMT partial measurement, age, sex)=JMT full measurement
M(surface data, DVT)=protrusion movement with tooth contact
M(JMT partial measurement)=JMT full measurement
M(opening movement JMT)=protrusion movement
M(opening movement JMT, protrusion movement with 0° jaw opening)=protrusion movement with 10° jaw opening
M(surface data)=protrusion movement with tooth contact
M(surface data)=laterotrusion with tooth contact
M(surface data, DVT)=protrusion movement with tooth contact
M(opening movement)=lateral movement
M(anatomy DVT, opening movement JMT)=lateral movement
M(masticatory movement)=opening movement
M(masticatory movement)=JMT full measurement
M(opening movement JMT)=laterotrusion movement
M(opening movement JMT)=protrusion movement
M(anatomy 3D imaging)=opening movement
M(surface data)=protrusion with tooth contact
M(surface data)=laterotrusion with tooth contact

A JMT data set 36 recorded on the patient 34 (and this also applies to the other data sets) can never represent all movements that the patient 34 is able to carry out. As shown above, the model M 30 supplements the incomplete data sets or a combination of data sets to give different, simulated patient-specific movements over the entire possible movement scope of the masticatory apparatus.

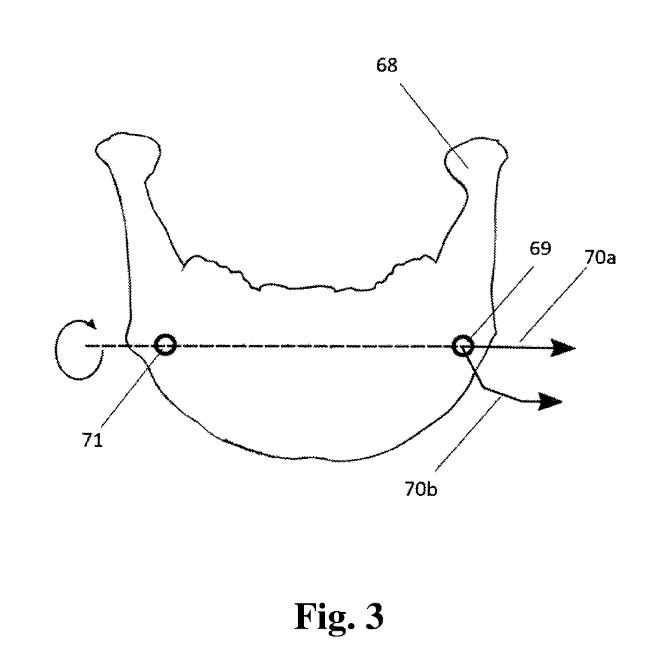

The chronological playback of the individual movement phases previously recorded is referred to as temporal articulation. Alternatively, by way of example, the mandible 68 can be manipulated directly in its position in space with the aid of the virtual articulator 40. This is tantamount to the guided manipulation of the patient's mandible by the practitioner. This is referred to as spatial articulation and is illustrated in FIG. 3.

In the schematically illustrated mandible 68 in FIG. 3, a first point 69 is marked and can be displaced along different movement paths 70a,b on the screen 48 according to the desire of the user operating the virtual articulator 40. The mandible 48 here follows, in a model-conforming manner, only with respect to the points that the mandible 48 of the patient 34 can assume in reality. If a second point 71 is additionally defined, it then follows that the rotation about the axis formed by the points 69, 71 remains as sole remaining degree of freedom. The virtual articulator 40 performs that movement which comes closest to the rotational movement about the axis or which follows or can be assumed with high probability. A probability cloud indicating with what probability the patient can actually assume the position is displayed on the screen 48.

The position and the location of the mandible 48 can, for example, be determined not only by the current position of the point 69 but also (for hysteresis reasons) by the position assumed by the mandible 68 directly beforehand.

In an embodiment of the present invention, movements, JMT data sets, DVT data sets and/or optical surface data of the teeth are recorded on the patient 34 and used as input variables. The method according to the present invention contains data of other patients and also indications of findings or diseases of the other patients, which, for example, were established and input by a dentist and are assigned to very specific data sets. By recognizing patterns, correlations and regularities, the model M 30 is able to decide, on the basis of the data 36 of the patient 34, whether an illness is actually present and/or whether parts of the movement of the masticatory apparatus of the patient 34 are pathological.

By means of the virtual articulator 40 or the mathematical model M 30 according to the present invention, diagnoses or findings for the patient 34 can be established automatically. The probability of a specific diagnosis is indicated by a percentage. Specific parts of the masticatory movement recorded on the patient or sections thereof can automatically be identified as ill. A non-exhaustive listing of possible findings/diagnoses include:
M(JMT data)=restricted coordination; 60% probability
M(JMT data)=restricted movement capacity; 60% probability
M(JMT data)=asymmetrical opening movement; 80% probability
M(DVT data)=arthrosis in the left jaw joint; 70% probability
M(DVT data, JMT data)=arthrosis in the left jaw joint; 85% probability
M(JMT data, sex)=craniomandibular dysfunction (CMD); 70% probability
M(JMT data, sex, age)=CMD; 82% probability
M(JMT data)=CMD; 75% probability
M(JMT data)=displaced disk left; 80% probability
M(JMT data, DVT data)=displaced disk left; 95% probability
M(surface data)=bruxism; 65% probability
M(JMT data, DVT data, surface data)=displaced disk; 75% probability

Expediently, the findings can additionally be spatially and/or temporally restricted. The virtual articulator 40 or the model M 30 can indicate at what locations and/or in what movement phase of the DVT data and/or of the JMT data a finding was identified:
M(JMT data)=forward displaced disk left; 80% probability; opening movement at second 3 and closing movement at second 15
M(DVT data)=backward displaced disk left; 70% probability; opening movement at second 7 and closing movement at second 16

Specific movement sections can, for example, be provided with identification features and other additional information, so that within a JMT data set, for example, a logical distinction can be drawn between a jaw opening and a jaw closing via the corresponding identification features being assigned to the different states. By learning these identification features, the model M 30 is also able to identify and differentiate opening and closing movement portions for the patient 34 without a dentist having to explicitly carry out these differentiations.

In an embodiment of the present invention, a therapy recommendation can, for example, be generated by the virtual articulator 40. In this case, the data collection of the model M 30 has information about successful and/or failed treatments on the patients who form the data collection. On the basis of this additional information, the model M 30 can automatically generate therapy recommendations on the basis of treatments previously carried out successfully. For each therapy recommendation, a probability value and a significance value are indicated, with which healing of the patient 34 is statistically assessable, such that the healing success can be estimated:
M(JMT data)=Michigan splint in the maxilla with “Freedom in Centric” of 2 mm promises the greatest healing success
M(DVT data)=Michigan splint “Flat Plane” with 3 mm inhibition at the incisors promises the greatest healing success
M(JMT data, DVT)=Michigan splint with 6 mm inhibition for targeted load relief/decompression of the condyles promises the greatest healing success

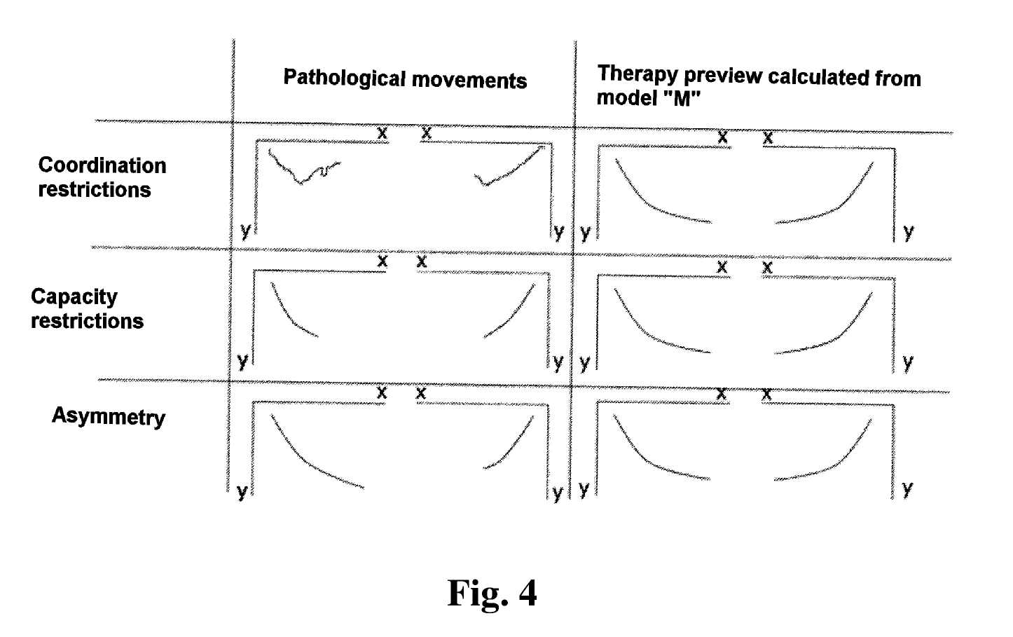

In an embodiment of the present invention, a therapy preview simulation can, for example, be generated and displayed by the virtual articulator 40. This shows how the current movements of the masticatory apparatus of the patient 34 behave in relation to a therapy simulation with specific therapy methods. By way of example, a restricted mobility of the jaw joints can be converted on the basis of the model M 30 as though the patient 34 had already undergone the therapy. This is possible since the model M 30 has “learned” the relationship between a diseased state and a healthy state on the basis of the data collection sets input into the model M 30. The model M 30 calculates how “μl” movements are converted into “healthy” movements by the therapy and represents the latter on the screen 48. One possible representation overview is shown in FIG. 4. In this case, the six degrees of freedom of the measured movements are visualized on the basis of the movement paths of characteristic points in the jaw joints and/or the teeth. Different patterns occur depending on the pathology. In this regard, the movement paths in the case where the patient exhibits a coordination restriction are usually rough and shaky. In the case of capacity restrictions, the paths are shortened since the patient can no longer open the mouth completely. In the case of an asymmetrical pathology, the path of one jaw joint is longer than that of the other jaw joint. The left-hand column in FIG. 4 shows pathological movements that were measured on the patient 34.

The right-hand column shows the movements calculated on the basis of the data collection from the pathological movements for the patient 34 with application of a corresponding therapy:
M(JMT data with restricted mouth opening)=JMT data with full mouth opening
M(JMT data with coordination restrictions)=JMT data without coordination restrictions
M(JMT data with asymmetrical mouth opening)=JMT data with symmetrical mouth opening
M(JMT data with restricted mouth opening, DVT data)=JMT data with full mouth opening
M(JMT data with disk displacement)=JMT data without disk displacement

The therapy preview simulation makes it possible to produce for the patient 34 a splint that optimally matches said patient's jaw joints even if movement sequences have not yet been measured on the patient 34. Restorations and/or functional jaw-orthopedic treatments can thus be planned at an early stage since the individual masticatory movement of the patient 34 that is to be striven for is known.

In an embodiment of the present invention, an automatic design of effective and precise therapy aids can, for example, be made possible with the aid of the model M 30 according to the present invention. In this regard, it is possible, for example, to produce precise occlusal splints such as, for example, therapy splints, tabletops or temporary prostheses which have functional mastication surfaces and disturbance-free occlusal reliefs. Manual grinding in the mouth of the patient 34 is minimized and a better fit is thereby provided:
M(JMT data, DVT data, optical surface data)=geometry for a therapy splint

In an embodiment of the present invention, automatic therapy planning with regard to the optimum jaw-orthopedic deployment of the teeth present can, for example, be generated via the virtual articulator 40 or the model M 30:
M(JMT data, surface data)=optimum jaw-orthopedic target position of the teeth for the given movement data
M(JMT data, DVT data, surface data)=optimum deployment of the teeth for the given movement data taking account of the roots of the teeth
M(JMT data, DVT data, optical surface data)=geometry of a therapy splint set

In an embodiment of the present invention, optimum restorative care can, for example, be provided via the virtual articulator 40:
M(JMT data, surface data)=optimum restoration

In an embodiment of the present invention, when replacing missing teeth, a precise shape for the crown to be inserted can, for example, be calculated via the model M 30:
M(JMT data, surface data left side of jaw)=surface data right side of jaw
M(JMT data, surface data with missing tooth 23, DVT data)=individual dynamic crown which matches the movement data with an automatically planned implant in the bone

The above-explained calculation examples via the model M 30 are of course not exhaustive and further calculation options do not depart from the scope of the present invention and can be represented via the virtual articulator. Reference should also be had to the appended claims.

What is claimed is:

1-20. (canceled)

21: A method for producing a computer-aided virtual articulator for dentistry, the method comprising:
recording and collating body-related data from a plurality of persons to provide a data collection;
generating a model of a masticatory apparatus from the data collection via statistical methods; and
using the model to supplement body-related data recorded from a single patient,
to provide a simulated individual movement model of the masticatory apparatus of the single patient, and
to simulate a movement of the masticatory apparatus.

22: The method as recited in claim 21, further comprising:
transmitting the body-related data of the single patient via an interface; and
adding the body-related data of the single patient to the data collection.

23: The method as recited in claim 21, wherein each of the body-related data comprises data from at least one of at least one imaging method, from anamnesis, and movement data.

24: The method as recited in claim 23, wherein the anamnesis comprises data on at least one of,
a sex,
a height,
an age,
an origin,
a body mass index (BMI),
a pre-existing condition,
a finding, and
a treatment-relevant characteristic,
of the single patient.

25: The method as recited in claim 23, further comprising:
using the data from the anamnesis to form different patient populations for the model; and
assigning the single patient to at least one of the different patient populations.

26: The method as recited in claim 25, further comprising:
generating a dedicated model of the masticatory apparatus for each of the patient populations.

27: The method as recited in claim 23, wherein the at least one imaging method comprises at least one of,
a digital volumetric tomographic data recording (DTV),
a data recording via a jaw motion tracking (JMT) system, and
another measuring method configured to describe an anatomy of the masticatory apparatus.

28: The method as recited in claim 27, wherein the at least one imaging method is configured to produce imaging data, and the method further comprises:
introducing the imaging data from at least two of the at least one imaging method into a common reference system.

29: The method as recited in claim 28, wherein each of the body-related data comprises at least one of surface data of teeth and bite forces of the masticatory apparatus.

30: The method as recited in claim 29, wherein the bite forces of the masticatory apparatus are determined based on a temporal profile of an occlusion of the teeth which is recorded by at least one of the at least one imaging method and the movement data.

31: The method as recited in claim 23, wherein the data recorded by the at least one imaging method comprises at least one of,
recordings of a plurality of movement phases of the masticatory apparatus, and
recordings of the plurality of movement phases at different points in time, and
the plurality of movement phases are labeled with therapy-relevant information.

32: The method as recited in claim 21, wherein the computer-aided virtual articulator is configured to,
display the simulated individual movement model of the single patient on a display device,
display further output information on the display device, and
provide a therapy preview simulation.

33: The method as recited in claim 32, wherein the further output information displayed on the display device of the computer-aided virtual articulator indicates whether the body-related data recorded from the single patient is sufficient to produce the simulated individual movement model and which measurement(s), if any, must still be performed.

34: The method as recited in claim 33, wherein a movement of selected distinctive points of the masticatory apparatus is displayed on the display device via the computer-aided virtual articulator.

35: The method as recited in claim 33, wherein,
during the display of the simulated individual movement model on the display device, anatomical points of the masticatory apparatus are fixed with regard to at least one of a translational movement and a rotational movement, and
the computer-aided virtual articulator is further configured to automatically calculate and indicate resultant degrees of freedom of the simulated individual movement model.

36: The method as recited in claim 32, wherein the further output information indicates at least one of,
with what probability the single patient should be assigned to at least one of a patient population, and
with what probability a specific disease or a specific finding for the single patient is present.

37: The method as recited in claim 21, wherein the simulated individual movement model of the masticatory apparatus of the single patient is output as a digital volumetric tomographic data set with surface data of at least a portion of the teeth of the single patient.

38: The method as recited in claim 21, wherein the model uses finite element methods.

39: The method as recited in claim 21, further comprising:
making the computer-aided virtual articulator available to external users via an interface so as to provide the simulated individual movement model of the masticatory apparatus of the single patient,
wherein,
the data collection is thereby maintained as confidential so as to remain inaccessible to the external users.

40: A device for performing the method as recited in claim 21, the device comprising:
an apparatus configured to record an imaging data set of the masticatory apparatus of patients;
an interface configured to transmit the imaging data set to a computer;
a processor unit of the computer for producing a computer-aided virtual articulator; and
a display device configured to display the virtual articulator.
